(19) United States
(12) Patent Application Publication
(10) Pub. No.: US 2025/0299374 A1
(43) Pub. Date: Sep. 25, 2025

(54) ATTRIBUTE TRANSFORMATION ENCODING METHOD, ATTRIBUTE TRANSFORMATION DECODING METHOD, AND TERMINAL

(71) Applicant: VIVO MOBILE COMMUNICATION CO., LTD., Dongguan (CN)

(72) Inventors: Wei ZHANG, Dongguan (CN); Xiaoyu LIU, Dongguan (CN); Fuzheng YANG, Dongguan (CN); Zhuoyi LV, Dongguan (CN)

(21) Appl. No.: 19/227,645

(22) Filed: Jun. 4, 2025

Related U.S. Application Data
(63) Continuation of application No. PCT/CN2023/136032, filed on Dec. 4, 2023.

(30) Foreign Application Priority Data
Dec. 9, 2022 (CN) 202211584468.0

(51) Int. Cl. G06T 9/00; G06T 9/40

(52) U.S. Cl. CPC G06T 9/001; G06T 9/40

(57) ABSTRACT

An attribute transformation encoding method includes: generating a transform tree structure corresponding to a point cloud based on geometry information of the point cloud; performing a transformation operation on a first attribute coefficient corresponding to a child node of each first node in N layers by using a preset target transformation matrix, to determine a second attribute coefficient, and predicting a first attribute coefficient corresponding to each second node in the N layers, to determine an attribute coefficient residual; quantizing the second attribute coefficient, the attribute coefficient residual, and a first attribute coefficient corresponding to a child node of each first node in a top layer; and encoding the second attribute coefficient, the attribute coefficient residual, and the first attribute coefficient corresponding to the child node of each first node in the top layer of the N layers that are quantized and the geometry information, to generate a target bitstream.

### CROSS-REFERENCE TO RELATED APPLICATIONS

This application is a bypass continuation of International Application No. PCT/CN2023/136032, filed on Dec. 4, 2023, which claims the benefit of and priority to Chinese Patent Application No. 202211584468.0, filed on Dec. 9, 2022, the contents of both of which being incorporated by reference in their entireties herein.

### TECHNICAL FIELD

This application relates to the field of encoding and decoding technologies, and specifically relates to an attribute transformation encoding method, an attribute transformation decoding method, and a terminal.

### BACKGROUND

A point cloud is a set of discrete points that are irregularly distributed in space, and represent a spatial structure and surface properties of a three-dimensional object or scene.

Attribute transformation encoding is used in the process of encoding a point cloud. In this process, the point cloud is first reordered based on its geometry information. A multi-layer transform tree structure is then constructed. Next, a transformation matrix is applied to the attribute coefficients associated with each node in the tree structure to perform the attribute transformation encoding of the point cloud.

### BRIEF SUMMARY

Embodiments of this application provide an attribute transformation encoding method, an attribute transformation decoding method, and a terminal.

According to a first aspect, an attribute transformation encoding method is provided, including:

An encoder obtains geometry information of a to-be-encoded point cloud;
the encoder generates a transform tree structure corresponding to the to-be-encoded point cloud based on the geometry information of the to-be-encoded point cloud, where the transform tree structure includes N layers, and N is a positive integer greater than 1;
the encoder performs, by using a preset target transformation matrix, a transformation operation on a first attribute coefficient corresponding to a child node of each first node in the N layers, to determine a second attribute coefficient corresponding to each first node, and predicts a first attribute coefficient corresponding to each second node in the N layers, to determine an attribute coefficient residual corresponding to each second node, where the first node is a non-leaf node in the N layers, the second node is a node having no parent node in the N layers, and the target transformation matrix is a transformation matrix not including a floating point number;
the encoder performs quantization processing on the second attribute coefficient corresponding to each first node, the attribute coefficient residual corresponding to each second node, and a first attribute coefficient corresponding to a child node of each first node in a top layer of the N layers; and
the encoder encodes the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

According to a second aspect, an attribute transformation decoding method is provided, including:

A decoder obtains a target bitstream;
the decoder determines, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node, where the first node is a non-leaf node in the N layers, the second node is a node having no parent node in the N layers, and N is a positive integer greater than 1; and
the decoder performs, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determines, based on the attribute coefficient residual corresponding to each second node, a reconstructed attribute value corresponding to each second node in the N layers, where the target transformation matrix is a transformation matrix not including a floating point number.

According to a third aspect, an attribute transformation encoding apparatus is provided, including:
an obtaining module, configured to obtain geometry information of a to-be-encoded point cloud;
a generation module, configured to generate a transform tree structure corresponding to the to-be-encoded point cloud based on the geometry information of the to-be-encoded point cloud, where the transform tree structure includes N layers, and N is a positive integer greater than 1;
a first determining module, configured to perform, by using a preset target transformation matrix, a transformation operation on a first attribute coefficient corresponding to a child node of each first node in the N layers, to determine a second attribute coefficient corresponding to each first node, and predict a first attribute coefficient corresponding to each second node in the N layers, to determine an attribute coefficient residual corresponding to each second node, where the first node is a non-leaf node in the N layers, the second node is a node having no parent node in the N layers, and the target transformation matrix is a transformation matrix not including a floating point number;
a quantization module, configured to perform quantization processing on the second attribute coefficient corresponding to each first node, the attribute coefficient residual corresponding to each second node, and a first attribute coefficient corresponding to a child node of each first node in a top layer of the N layers; and
an encoding module, configured to encode the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

According to a fourth aspect, an attribute transformation decoding apparatus is provided, including:
an obtaining module, configured to obtain a target bitstream;
a determining module, configured to determine, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node, where the first node is a non-leaf node in the N layers, the second node is a node having no parent node in the N layers, and N is a positive integer greater than 1; and
a processing module, configured to perform, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determine, based on the attribute coefficient residual corresponding to each second node, a reconstructed attribute value corresponding to each second node in the N layers, where the target transformation matrix is a transformation matrix not including a floating point number.

According to a fifth aspect, a terminal is provided. The terminal includes a processor and a memory. The memory stores a program or instructions that may be run on the processor. When the program or the instructions are executed by the processor, the steps of the method according to the first aspect or the steps of the method according to the second aspect are implemented.

According to a sixth aspect, a readable storage medium is provided. The readable storage medium stores a program or instructions. When the program or the instructions are executed by a processor, the steps of the method according to the first aspect or the steps of the method according to the second aspect are implemented.

According to a seventh aspect, a chip is provided. The chip includes a processor and a communication interface. The communication interface is coupled to the processor. The processor is configured to run a program or instructions, to implement the step of the method according to the first aspect or implement the steps of the method according to the second aspect.

According to an eighth aspect, a computer program/program product is provided. The computer program/program product is stored in a storage medium. The computer program/program product is executed by at least one processor, to implement the steps of the method according to the first aspect or implement the steps of the method according to the second aspect.

### BRIEF DESCRIPTION OF THE DRAWINGS

FIG. 1 is a diagram of a framework of an AVS point cloud encoding apparatus;

FIG. 2 is a diagram of a framework of an AVS point cloud decoding apparatus;

FIG. 3 is a schematic flowchart of an attribute transformation encoding method according to an embodiment of this application;

FIG. 4 is a diagram of a transform tree structure according to an embodiment of this application;

FIG. 5 is a schematic flowchart of an attribute transformation decoding method according to an embodiment of this application;

FIG. 6 is a diagram of a structure of an attribute transformation encoding apparatus according to an embodiment of this application;

FIG. 7 is a diagram of a structure of an attribute transformation decoding apparatus according to an embodiment of this application;

FIG. 8 is a diagram of a structure of a communication device according to an embodiment of this application; and

FIG. 9 is a diagram of a hardware structure of a terminal according to an embodiment of this application.

### DETAILED DESCRIPTION

The following clearly describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application shall fall within the protection scope of this application.

In this specification and claims of this application, the terms “first”, “second”, and the like are intended to distinguish between similar objects but do not indicate a specific order or sequence. It should be understood that the terms used in such a way are interchangeable in appropriate circumstances, so that embodiments of this application can be implemented in other orders than an order illustrated or described herein, and objects distinguished by “first” and “second” are usually of the same category and a quantity of the objects is not limited. For example, there may be one or more first objects. In addition, the expression “and/or” in this specification and claims represents at least one of connected objects, and the character “/” generally indicates an “or” relationship between the associated objects.

Both an attribute transformation encoding apparatus corresponding to an attribute transformation encoding method and an attribute transformation decoding apparatus corresponding to an attribute transformation decoding method in embodiments of this application may be terminals. The terminal may also be referred to as a terminal device or a User Equipment (UE). The terminal may be a terminal-side device such as a mobile phone, a Tablet Personal Computer, a Laptop Computer or a notebook computer, a Personal Digital in Assistant (PDA), a handheld computer, a netbook, an ultra-mobile personal computer (UMPC), a Mobile Internet Device (MID), an augmented reality (AR)/virtual reality (VR) device, a robot, a Wearable Device or a Vehicle User Equipment (VUE), a Pedestrian User Equipment (PUE), a smart home (a home device having a wireless communication function, such as a refrigerator, a television, a washing machine, or furniture), a game console, a personal computer (PC), or a teller machine or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, smart clothing, and the like. It should be noted that, a specific type of the terminal is not limited in embodiments of this application.

For ease of understanding, some content related to embodiments of this application is described below.

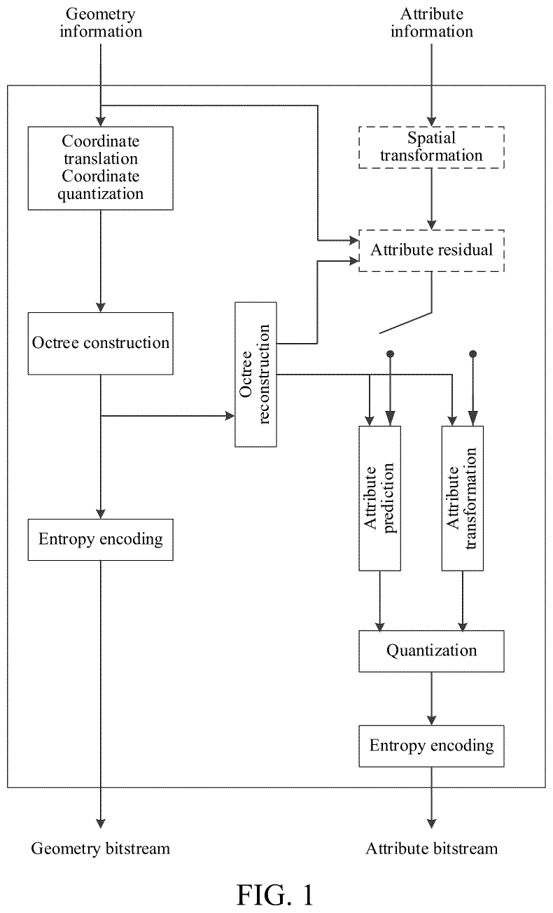

Turning now to the drawings, reference is made to FIG. 1. As shown in FIG. 1, currently, in a digital audio-video encoding and decoding technology standard, an AVS point cloud encoding apparatus is used to separately encode geometry information and attribute information of a point cloud. First, coordinate transformation is performed on the geometry information, so that the point cloud is entirely included in a bounding box, and then coordinate quantization is performed. Quantization mainly has a function of scaling. Because quantization rounds geometric coordinates, geometry information of some points is the same, where the points are referred to as duplicate points. Whether to remove the duplicate points is determined based on a parameter. The two steps, namely quantization and removing the duplicate points, are also referred to as a voxelization process. Next, multi-branch tree partitioning, for example, octree, quadtree, or binary tree partitioning, is performed on the bounding box. In a geometry information encoding framework based on a multi-branch tree, a bounding box is partitioned into eight equal sub-cubes, a non-empty sub-cube is further partitioned, and partitioning is stopped until a unit cube corresponding to a leaf node of 1×1×1 is obtained through partitioning. A point count in a leaf node is encoded, to generate a binary bitstream.

After geometry encoding is completed, the geometry information is reconstructed for subsequent recoloring. Attribute encoding mainly targets at color and reflectance information. First, it is determined, based on a parameter, whether to perform color space conversion. If the color space conversion is performed, color information is converted from a Red Green Blue (RGB) color space to a luminance-chrominance (YUV) color space. Then, a geometrically reconstructed point cloud is recolored by using an original point cloud, so that unencoded attribute information corresponds to the reconstructed geometry information. During color information encoding, after a point cloud is ordered by using Morton code or Hilbert code, a nearest neighbor of a to-be-predicted point is searched for based on a geometric spatial relationship, and the to-be-predicted point is predicted by using a reconstructed attribute value of a found neighbor, to obtain a predicted attribute value; then, a difference between an actual attribute value and the predicted attribute value is calculated, to obtain a prediction residual; and finally, the prediction residual is quantized and encoded, to generate a binary bitstream.

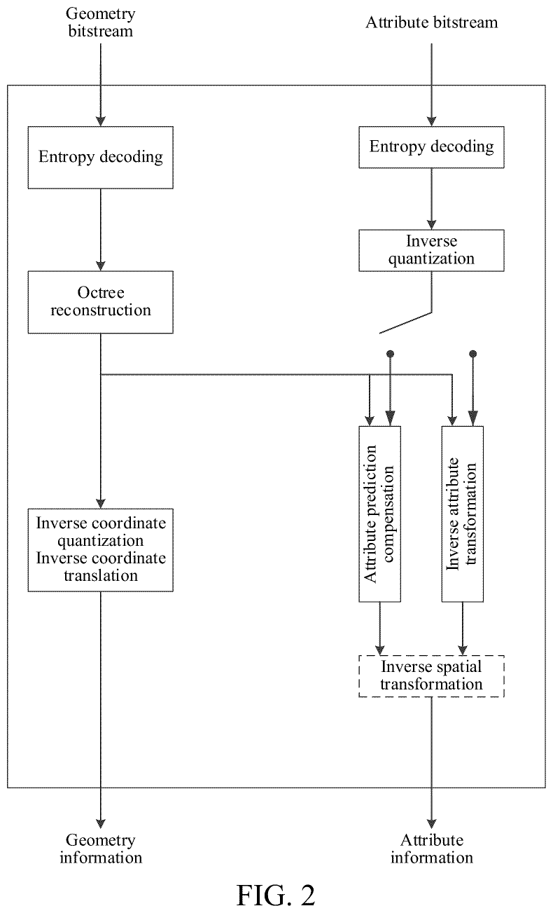

It should be understood that a decoding process in the digital audio-video encoding and decoding technology standard corresponds to the foregoing encoding process. Specifically, a framework of an AVS point cloud decoding apparatus is shown in FIG. 2.

Attribute transformation encoding is involved in a process of encoding a point cloud. In an attribute transformation encoding process, a point cloud is reordered based on geometry information of the point cloud and a multi-layer transform tree structure is constructed, and then transformation processing is performed on an attribute coefficient corresponding to each node in the transform tree structure by using a transformation matrix, to implement attribute transformation encoding on the point cloud. The foregoing transformation matrix includes a floating point number, and a plurality of times of calculation on the floating point number may reduce computational precision, which affects an encoding result.

This application provides an attribute transformation encoding method. The attribute transformation encoding method provided in embodiments of this application is described in detail below with reference to the accompanying drawings by using some embodiments and application scenarios thereof.

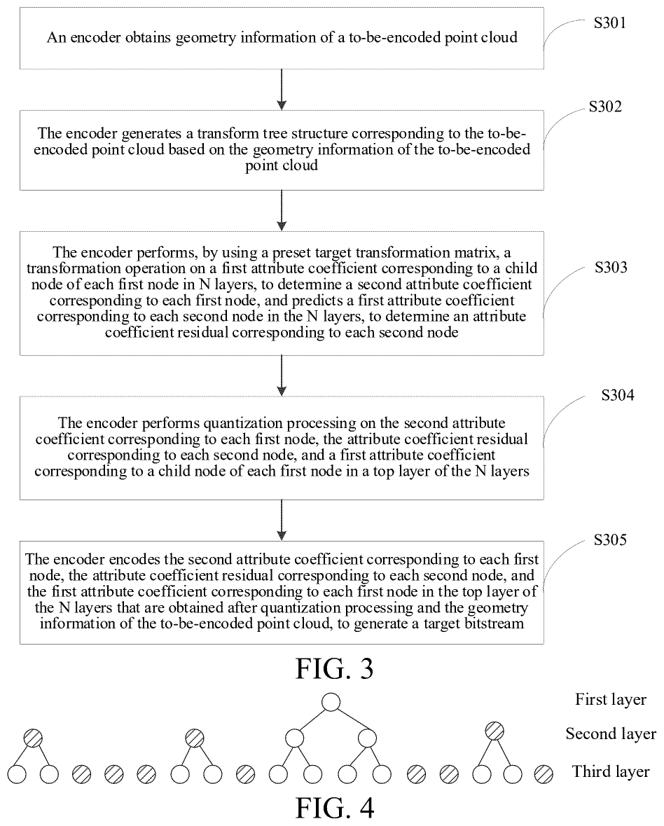

Refer to FIG. 3. FIG. 3 is a flowchart of an attribute transformation encoding method according to an embodiment of this application. The attribute transformation encoding method provided in this embodiment includes the following steps.
S301: An encoder obtains geometry information of a to-be-encoded point cloud.
S302: The encoder generates a transform tree structure corresponding to the to-be-encoded point cloud based on the geometry information of the to-be-encoded point cloud.

In this step, the geometry information of the to-be-encoded point cloud is obtained, and the to-be-encoded point cloud is reordered based on the geometry information. The transform tree structure corresponding to the to-be-encoded point cloud is constructed based on a geometric distance between points in the reordered to-be-encoded point cloud. It should be understood that the transform tree structure includes N layers, where N is a positive integer greater than 1.
S303: The encoder performs, by using a preset target transformation matrix, a transformation operation on a first attribute coefficient corresponding to a child node of each first node in the N layers, to determine a second attribute coefficient corresponding to each first node, and predicts a first attribute coefficient corresponding to each second node in the N layers, to determine an attribute coefficient residual corresponding to each second node.

In this step, the target transformation matrix is preset, and the transformation operation is performed, by using the preset target transformation matrix, on the first attribute coefficient corresponding to the child node of each first node, to determine the second attribute coefficient corresponding to each first node. The first node is a non-leaf node in the N layers, the first attribute coefficient is a DC coefficient, and the second attribute coefficient is an AC coefficient. For a specific technical solution on how to determine the first attribute coefficient corresponding to the child node of each first node, refer to subsequent content.

For example, refer to FIG. 4. A transform tree structure shown in FIG. 4 includes three layers. Nodes included in a first layer and a second layer are non-leaf nodes, namely first nodes. The transform tree structure shown in FIG. 4 includes six first nodes.

It should be understood that the target transformation matrix is a transformation matrix not including a floating point number.

In this step, the first attribute coefficient corresponding to each second node in the N layers is predicted, to determine the attribute coefficient residual corresponding to each second node. The second node is a node having no parent node in the N layers. For a specific technical solution on how to determine the first attribute coefficient corresponding to each second node, refer to subsequent content.

For example, refer to FIG. 4. The transform tree structure shown in FIG. 4 includes three layers. The transform tree structure shown in FIG. 4 includes ten second nodes.
S304: The encoder performs quantization processing on the second attribute coefficient corresponding to each first node, the attribute coefficient residual corresponding to each second node, and a first attribute coefficient corresponding to a child node of each first node in a top layer of the N layers.

In this step, after the second attribute coefficient corresponding to each first node and the attribute coefficient residual corresponding to each second node are obtained, quantization processing may be performed on the second attribute coefficient corresponding to each first node, the attribute coefficient residual corresponding to each second node, and the first attribute coefficient corresponding to each first node in the top layer of the N layers.
S305: The encoder encodes the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

In this step, after quantization processing is performed on the second attribute coefficient corresponding to each first node, the attribute coefficient residual corresponding to each second node, and the first attribute coefficient corresponding to each first node in the top layer of the N layers, the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud are encoded, to generate the target bitstream.

In this embodiment of this application, the transformation operation is performed, by using the preset target transformation matrix, on the first attribute coefficient corresponding to the child node of each first node, to determine the second attribute coefficient corresponding to each first node, where the target transformation matrix is a transformation matrix not including a floating point number. Compared with a manner in a related technology in which transformation processing is performed, by using a transformation matrix including a floating point number, on an attribute coefficient corresponding to a node, in embodiments of this application, transformation processing is performed on an attribute coefficient by using a transformation matrix not including a floating point number, to avoid loss of computational precision, thereby improving accuracy of an encoding result.

In some embodiments, before performing quantization processing on the second attribute coefficient corresponding to each first node, the attribute coefficient residual corresponding to each second node, and the first attribute coefficient corresponding to the child node of each first node in the top layer of the N layers, the method further includes:

The encoder performs, based on N, a division operation on the first attribute coefficient corresponding to the child node of each first node in the top layer of the N layers; and
the encoder performs, based on N and a quantity of layers that corresponds to a first layer, a division operation on a second attribute coefficient corresponding to each first node included in the first layer, and performs, based on N and the quantity of layers that corresponds to the first layer, a division operation on an attribute coefficient residual corresponding to each second node included in the first layer, where the first layer is any layer other than the top layer in the N layers.

In this embodiment, for the top layer of the N layers, the division operation is performed, based on a total quantity, namely N, of layers included in the transform tree structure, on a first attribute coefficient corresponding to each first node in the top layer.

In some embodiments, the first attribute coefficient corresponding to each first node in the top layer may be divided by (\sqrt{2})^{N}, where N is the total quantity of layers included in the transform tree structure.

In this embodiment, for the first layer of the N layers, the division operation may be performed, based on the total quantity, namely N, of layers included in the transform tree structure and the quantity of layers that corresponds to the first layer, on the attribute coefficient residual corresponding to each second node in the first layer, where the first structure is any layer other than the top layer in the N layers.

In some embodiments, the second attribute coefficient corresponding to each first node in the first layer may be divided by (\sqrt{2})^{N-b+1}, where N is the total quantity of layers included in the transform tree structure, and n is the quantity of layers that corresponds to the first layer.

In this embodiment, after the transformation operation is performed on the attribute coefficient by using the target transformation matrix, the division operation is performed, based on different layers on which nodes are located, on the attribute coefficient corresponding to each node, to correct the attribute coefficient corresponding to each node and ensure that the attribute coefficient corresponding to each node is an accurate attribute coefficient, thereby avoiding an encoding error.

In some embodiments, before performing quantization processing on the second attribute coefficient corresponding to each first node, the attribute coefficient residual corresponding to each second node, and the first attribute coefficient corresponding to the child node of each first node in the top layer of the N layers, the method further includes:

In a case that N is an even number, the encoder performs, based on N, a shift operation on the first attribute coefficient corresponding to the child node of each first node in the top layer of the N layers; or
in a case that N is an odd number, the encoder performs a division operation on the first attribute coefficient corresponding to the child node of each first node in the top layer of the N layers, and performs, based on N, a shift operation on a first attribute coefficient corresponding to each first node in the top layer of the N layers.

In this embodiment, for the top layer of the N layers, in a case that N is an even number, the shift operation may be performed on the first attribute coefficient corresponding to the child node of each first node in the top layer. In some embodiments, the first attribute coefficient corresponding to the child node of each first node in the top layer may be right-shifted by N/2 bits.

In a case that N is an odd number, the division operation and the shift operation may be performed on the first attribute coefficient corresponding to the child node of each first node in the top layer. In some embodiments, the first attribute coefficient corresponding to the child node of each first node in the top layer may be right-shifted by (N−1)/2 bits, and then the shifted first attribute coefficient is divided by \sqrt{2}. It should be understood that, in another embodiment, alternatively, a division operation may be first performed, and then a shift operation is performed.

In some embodiments, the method further includes:

In a case that a first value is an even number, the encoder performs, based on the first value, a shift operation on a second attribute coefficient corresponding to each first node included in a first layer, where the first value is determined based on N and a quantity of layers that corresponds to the first layer, and the first layer is any layer other than the top layer in the N layers; or
in a case that a first value is an odd number, the encoder performs a division operation on a second attribute coefficient corresponding to each first node included in a first layer, and performs, based on the first value, a shift operation on the second attribute coefficient corresponding to each first node included in the first layer; or
in a case that a second value is an even number, the encoder performs, based on the second value, a shift operation on an attribute coefficient residual corresponding to each second node included in a first layer, where the second value is determined based on N and a quantity of layers that corresponds to the first layer, and the second value is greater than the first value; or
in a case that a second value is an odd number, the encoder performs a division operation on an attribute coefficient residual corresponding to each second node included in a first layer, and performs, based on the second value, a shift operation on the attribute coefficient residual corresponding to each second node included in the first layer.

In this embodiment, for the first layer of the N layers, in a case that the first value is an even number, the shift operation may be performed on the second attribute coefficient corresponding to each first node included in the first layer. In a case that the first value is an odd number, the division operation may be performed on the second attribute coefficient corresponding to each first node included in the first layer, and the shift operation may be performed on the second attribute coefficient obtained after the division operation. The first value is determined based on the total quantity of layers included in the transform tree structure and the quantity of layers that corresponds to the first layer.

In some embodiments, the first value is N−n+1, where N is the total quantity of layers included in the transform tree structure, and n is the quantity of layers that corresponds to the first layer. In a case that the first value is an odd number, the second attribute coefficient corresponding to each first node included in the first layer is divided by \sqrt{2}, and then the second attribute coefficient obtained after the division operation is right-shifted by (N−n)/2 bits. It should be understood that, in another embodiment, alternatively, a shift operation may be first performed, and then a division operation is performed. In a case that the first value is an even number, the second attribute coefficient corresponding to each first node included in the first layer is right-shifted by (N−n)/2 bits.

In this embodiment, for the first layer of the N layers, in a case that the second value is an even number, the shift operation may be performed on the attribute coefficient residual corresponding to each second node included in the first layer. In a case that the second value is an odd number, the division operation may be performed on the attribute coefficient residual corresponding to each second node included in the first layer, and the shift operation may be performed on the attribute coefficient residual obtained after the division operation. The second value is determined based on the total quantity of layers included in the transform tree structure and the quantity of layers that corresponds to the first layer.

In some embodiments, the second value is N−30 2, where Nis the total quantity of layers included in the transform tree structure, and n is the quantity of layers that corresponds to the first layer. In a case that the second value is an odd number, the attribute coefficient residual corresponding to each second node included in the first layer is divided by \sqrt{2}, and then the attribute coefficient residual obtained after the division operation is right-shifted by (N−n+1)/2 bits. It should be understood that, in another embodiment, alternatively, a shift operation may be first performed, and then a division operation is performed. In a case that the second value is an even number, the attribute coefficient residual corresponding to each second node included in the first layer is right-shifted by (N−n+1)/2 bits.

In some embodiments, performing quantization processing on the second attribute coefficient corresponding to each first node, the attribute coefficient residual corresponding to each second node, and the first attribute coefficient corresponding to the child node of each first node in the top layer of the N layers includes:

The encoder performs, by using a first quantization step, quantization processing on the first attribute coefficient corresponding to the child node of each first node in the top layer of the N layers, where the first quantization step is determined based on N;
the encoder performs, by using a second quantization step, quantization processing on a second attribute coefficient corresponding to a first node in a first layer, where the second quantization step is determined based on N and a quantity of layers that corresponds to the first layer, and the first layer is any layer other than the top layer in the N layers; and
the encoder performs, by using a third quantization step, quantization processing on an attribute coefficient residual corresponding to a second node in the first layer, where the third quantization step is determined based on N and the quantity of layers that corresponds to the first layer, and the third quantization step is greater than or equal to the second quantization step.

In this embodiment, for each first node in the top layer of the N layers, quantization processing may be performed, by using the first quantization step, on the first attribute coefficient corresponding to the child node of the first node, where the first quantization step is determined based on N.

In some embodiments, the first quantization step may be determined by using the following formula:

$${QP}^{′} = QP + 4 \times N$$

where QP′ is the first quantization step, QP is a preset quantization step, and Nis the total quantity of layers included in the transform tree structure.

In this embodiment, for the first node in the first layer, quantization processing may be performed, by using the second quantization step, on the second attribute coefficient corresponding to the first node, where the second quantization step is determined based on N and the quantity of layers that corresponds to the first layer, and the first layer is any layer other than the top layer in the N layers.

In some embodiments, the second quantization step may be determined by using the following formula:

$${QP}^{′} = QP + 4 \times ( N - n + 1 )$$

where QP′ is the first quantization step, QP is a preset quantization step, N is the total quantity of layers included in the transform tree structure, and n is the quantity of layers that corresponds to the first layer.

In this embodiment, for each second node in the first layer, quantization processing may be performed, by using the third quantization step, on the attribute coefficient residual corresponding to the second node, where the third quantization step is determined based on N and the quantity of layers that corresponds to the first layer.

In some embodiments, the third quantization step may be determined by using the following formula:

$${QP}^{′} = QP + 4 \times ( N - n + 2 )$$

where QP′ is the first quantization step, QP is a preset quantization step, N is the total quantity of layers included in the transform tree structure, and n is the quantity of layers that corresponds to the first layer.

In this embodiment, after the transformation operation is performed on the attribute coefficient by using the target transformation matrix, quantization processing is performed, by using different quantization steps based on different layers on which nodes are located, on the attribute coefficient corresponding to each node, to correct the attribute coefficient corresponding to each node and ensure that the attribute coefficient corresponding to each node is an accurate attribute coefficient, thereby avoiding an encoding error.

The following describes in detail how to determine the first attribute coefficient corresponding to the child node of each first node and the first attribute coefficient corresponding to each second node.

In some embodiments, before performing, by using the preset target transformation matrix, the transformation operation on the first attribute coefficient corresponding to the child node of each first node in the N layers, to determine the second attribute coefficient corresponding to each first node, and predicting the first attribute coefficient corresponding to each second node in the N layers, to determine the attribute coefficient residual corresponding to each second node, the method further includes:

The encoder determines an original attribute value corresponding to each node in a bottom layer of the N layers as a first attribute coefficient corresponding to each node in the bottom layer of the N layers; and
the encoder performs, based on the target transformation matrix, a transformation operation on a first attribute coefficient corresponding to a child node of each node in a second layer, to determine a first attribute coefficient corresponding to each node, where the second layer is any layer other than the bottom layer in the N layers.

In this embodiment, for the bottom layer in the N layers, the original attribute value corresponding to each node in the bottom layer may be determined as the first attribute coefficient corresponding to each node.

For any layer other than the bottom layer in the N layers, a first attribute coefficient corresponding to a child node of each node in the layer is obtained, and a transformation operation is performed, based on a target transformation matrix, on the first attribute coefficient corresponding to the child node, to determine a first attribute coefficient corresponding to each node. It should be understood that the target transformation matrix is a transformation matrix not including a floating point number.

For example, refer to FIG. 4. In the transform tree structure shown in FIG. 4, an original attribute value corresponding to each node in a third layer is determined as a first attribute coefficient corresponding to each node in the third layer.

Some nodes in the third layer are child nodes of a node in the second layer. A transformation operation is performed, based on the target transformation matrix, on a first attribute coefficient corresponding to a child node of each node in the second layer, to determine a first attribute coefficient corresponding to each node in the second layer.

Some nodes in the second layer are child nodes of a node in the first layer. A transformation operation is performed, based on the target transformation matrix, on a first attribute coefficient corresponding to a child node of each node in the first layer, to determine a first attribute coefficient corresponding to each node in the first layer.

In some embodiments, the target transformation matrix is a matrix with two rows and two columns. The target transformation matrix includes a first component, a second component, a third component, and a fourth component. The value of the first component and the value of the second component are different. The value of the third component and the value of the second component are the same, and the value of the fourth component is an opposite number of the value of the first component; or the value of the third component is an opposite number of the value of the second component, and the value of the fourth component and the value of the first component are the same.

The first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

In an optional implementation, the target transformation matrix may be represented as

$$[ \begin{matrix}A & B \\ B & - A\end{matrix} ] .$$

In another optional implementation, the target transformation matrix may be represented as

$$[ \begin{matrix}A & B \\ - B & A\end{matrix} ] .$$

For example, A and B may be a same value, that is, the target transformation matrix may be represented as

$$[ \begin{matrix}1 & 1 \\ 1 & - 1\end{matrix} ] .$$

It should be understood that, according to the attribute transformation encoding method provided in this embodiment of this application, computational complexity of the encoder may be further reduced. For ease of understanding, refer to Table 1.

TABLE 1

| | Quantity of | Quantity of | Quantity of |
|---|---|---|---|
| | addition | subtraction | division |
| | operation times | operation times | operation times |
| Encoder 1 | 12387630 | 12387630 | 24775260 |
| Encoder 2 | 12387694 | 12387662 | 0 |

It should be understood that, the encoder 1 in Table 1 is an encoder that uses an attribute transformation encoding method in a related technology, and the encoder 2 is an encoder that uses the attribute transformation encoding method provided in this embodiment of this application. As shown in Table 1, compared with the attribute transformation encoding method in the conventional technology, a quantity of division operations is effectively reduced on the encoder that uses the attribute transformation encoding method provided in this embodiment of this application, thereby reducing the computational complexity of the encoder.

It should be understood that, according to the attribute transformation encoding method provided in this embodiment of this application, encoding performance may be further improved. For ease of understanding, refer to Table 2.

TABLE 2

| | Luminance | Chrominance | Chrominance |
|---|---|---|---|
| | component (Y) | component (U) | component (V) |
| Point cloud file 1 | | | |
| Point cloud type 1 | / | / | / |
| Point cloud type 2 | −0.4% | −3.5% | −3.0% |
| Point cloud type 3 | −0.2% | −2.0% | −1.3% |
| Point cloud type 4 | / | / | / |
| Point cloud type 5 | −0.4% | −3.5% | −5.4% |
| Point cloud file 2 | | | |
| Point cloud type 1 | / | / | / |
| Point cloud type 2 | −0.6% | −3.4% | −2.6% |
| Point cloud type 3 | −0.7% | −0.8% | −2.8% |
| Point cloud type 4 | / | / | / |
| Point cloud type 5 | −0.9% | −5.2% | −8.9% |

It should be noted that, the point cloud file 1 and the point cloud file 2 may be avsc files storing point clouds. The point cloud types are different data types corresponding to the point clouds. In some embodiments, the point cloud type 1 may be represented as “AVSCat1A”, the point cloud type 2 may be represented as “AVSCat1B”, the point cloud type 3 may be represented as “AVSCat1C”, the point cloud type 4 may be represented as “AVSCat2-frame”, and the point cloud type 5 may be represented as “AVSCat3”.

It should be noted that, values in Table 2 represent encoding performance indicated by an encoder. For example, “−3.5%” in a third row and a third column in Table 2 indicates that, compared with the related technology, encoding performance when the chrominance component (U) is encoded can be improved by 3.5% by using the attribute transformation encoding method provided in this embodiment of this application.

It can be learned from Table 2 that, according to the attribute transformation encoding method provided in this embodiment of this application, encoding performance of each component can be improved, thereby improving overall encoding performance.

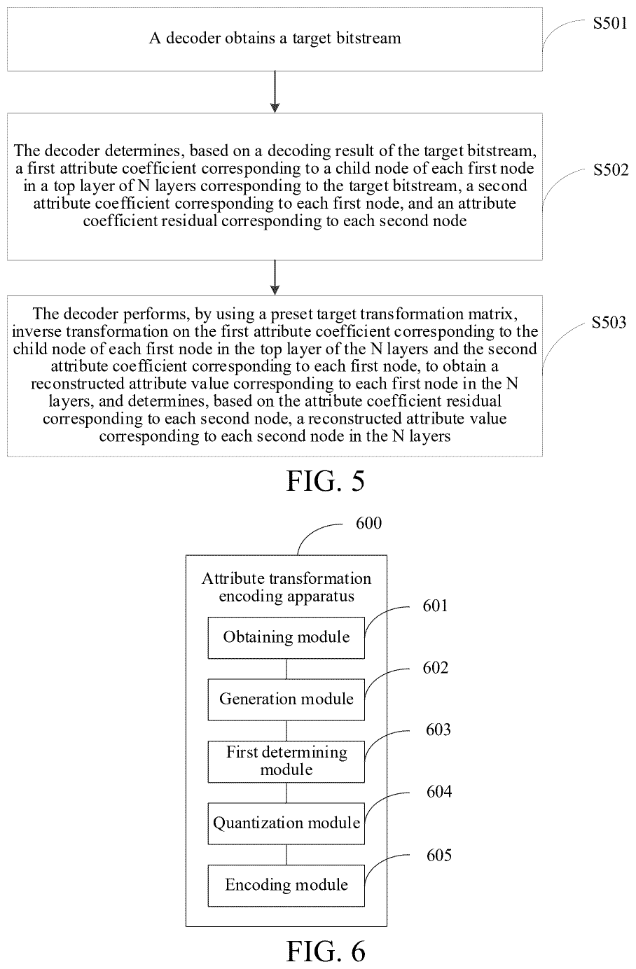

Refer to FIG. 5. FIG. 5 is a schematic flowchart of an attribute transformation decoding method according to an embodiment of this application. The attribute transformation decoding method provided in this embodiment includes the following steps.
S501: A decoder obtains a target bitstream.
S502: The decoder determines, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node.

The first node is a non-leaf node in the N layers, the second node is a node having no parent node in the N layers, and N is a positive integer greater than 1.
S503: The decoder performs, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determines, based on the attribute coefficient residual corresponding to each second node, a reconstructed attribute value corresponding to each second node in the N layers.

The target transformation matrix is a transformation matrix not including a floating point number.

In this embodiment of this application, the inverse transformation is performed, by using the preset target transformation matrix, on the first attribute coefficient corresponding to the child node of each first node and the second attribute coefficient corresponding to each first node, to obtain the reconstructed attribute value corresponding to each first node. In this embodiment of this application, inverse transformation processing is performed on an attribute coefficient by using a transformation matrix not including a floating point number, to avoid loss of computational precision, thereby improving accuracy of an encoding result.

In some embodiments, determining, based on the decoding result of the target bitstream, the first attribute coefficient corresponding to the child node of each first node in the top layer of the N layers corresponding to the target bitstream, the second attribute coefficient corresponding to each first node, and the attribute coefficient residual corresponding to each second node includes:

The decoder decodes the obtained target bitstream, to obtain geometry information of a to-be-decoded point cloud, a first target attribute coefficient corresponding to each first node in the top layer of the N layers, a second target attribute coefficient corresponding to each first node, and a target attribute coefficient residual corresponding to each second node; and
the decoder constructs a transform tree structure based on the geometry information of the to-be-decoded point cloud, and performs dequantization processing on the first target attribute coefficient corresponding to each first node in the top layer of the N layers, the second target attribute coefficient corresponding to each first node, and the target attribute coefficient residual corresponding to each second node, to obtain the first attribute coefficient corresponding to the child node of each first node in the top layer of the N layers, the second attribute coefficient corresponding to each first node, and the attribute coefficient residual corresponding to each second node.

In this embodiment, the target bitstream is decoded, to obtain the geometry information of the to-be-decoded point cloud, and then the transform tree structure is constructed based on the geometry information of the to-be-decoded point cloud.

It should be understood that the specific process of performing dequantization processing on the second target attribute coefficient corresponding to each first node and the target attribute coefficient residual corresponding to each second node is an inverse process of quantization processing performed in the foregoing embodiment. Details are not described herein again.

In some embodiments, performing dequantization processing on the first target attribute coefficient corresponding to each first node in the top layer of the N layers, the second target attribute coefficient corresponding to each first node, and the target attribute coefficient residual corresponding to each second node includes:

The decoder performs, by using a first quantization step, dequantization processing on the first target attribute coefficient corresponding to each first node in the top layer of the N layers, where the first quantization step is determined based on N;
the decoder performs, by using a second quantization step, quantization processing on a second target attribute coefficient corresponding to a first node in a first layer, where the second quantization step is determined based on N and a quantity of layers that corresponds to the first layer, and the first layer is any layer other than the top layer in the N layers; and
the decoder performs, by using a third quantization step, quantization processing on a target attribute coefficient residual corresponding to a second node in the first layer, where the third quantization step is determined based on N and the quantity of layers that corresponds to the first layer, and the third quantization step is greater than or equal to the second quantization step.

It should be understood that, in this embodiment, the specific process of performing quantization processing by using the first quantization step, the second quantization step, and the third quantization step is an inverse process of quantization processing performed in the foregoing embodiment. Details are not described herein again.

In some embodiments, before performing, by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the method further includes:

The decoder performs, based on N, a multiplication operation on the first attribute coefficient corresponding to the child node of each first node in the top layer of the N layers; and
the decoder performs, based on N and a quantity of layers that corresponds to a first layer, a multiplication operation on a second attribute coefficient corresponding to each first node included in the first layer, and performs, based on N and the quantity of layers that corresponds to the first layer, a multiplication operation on an attribute coefficient residual corresponding to each second node included in the first layer, where the first layer is any layer other than the top layer in the N layers.

In some embodiments, before performing, by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the method further includes:

In a case that N is an even number, the decoder performs, based on N, a shift operation on the first attribute coefficient corresponding to the child node of each first node in the top layer of the N layers; or
in a case that Nis an odd number, the decoder performs a multiplication operation on the first attribute coefficient corresponding to the child node of each first node in the top layer of the N layers, and performs, based on N, a shift operation on a first attribute coefficient corresponding to each first node in the top layer of the N layers.

It should be understood that, in a case that a shift operation performed by an encoder is a right-shift operation, a shift operation performed by the decoder is a left-shift operation.

In some embodiments, the method further includes:

In a case that a first value is an even number, the decoder performs, based on the first value, a shift operation on a second attribute coefficient corresponding to each first node included in a first layer, where the first value is determined based on N and a quantity of layers that corresponds to the first layer, and the first layer is any layer other than the top layer in the N layers; or
in a case that a first value is an odd number, the decoder performs a multiplication operation on a second attribute coefficient corresponding to each first node included in a first layer, and performs, based on the first value, a shift operation on the second attribute coefficient corresponding to each first node included in the first layer; or
in a case that a second value is an even number, the decoder performs, based on the second value, a shift operation on an attribute coefficient residual corresponding to each second node included in a first layer, where the second value is determined based on N and a quantity of layers that corresponds to the first layer, and the second value is greater than the first value; or
in a case that a second value is an odd number, the decoder performs a multiplication operation on an attribute coefficient residual corresponding to each second node included in a first layer, and performs, based on the second value, a shift operation on the attribute coefficient residual corresponding to each second node included in the first layer.

It should be understood that, if the encoder first performs a division operation on a second attribute coefficient, and then performs a shift operation on the second attribute coefficient obtained after the division operation, the decoder first performs a multiplication operation on the second attribute coefficient, and then performs a shift operation on the second attribute coefficient obtained after the multiplication operation.

If the encoder first performs a shift operation on a second attribute coefficient, and then performs a division operation on the second attribute coefficient obtained after the shift operation, the decoder first performs a shift operation on the second attribute coefficient, and then performs a multiplication operation on the second attribute coefficient obtained after the shift operation.

It should be understood that, if the encoder first performs a division operation on an attribute coefficient residual, and then performs a shift operation on the attribute coefficient residual obtained after the division operation, the decoder first performs a multiplication operation on the attribute coefficient residual, and then performs a shift operation on the attribute coefficient residual obtained after the multiplication operation.

If the encoder first performs a shift operation on an attribute coefficient residual, and then performs a division operation on the attribute coefficient residual obtained after the shift operation, the decoder first performs a shift operation on the attribute coefficient residual, and then performs a multiplication operation on the attribute coefficient residual obtained after the shift operation.

In some embodiments, the target transformation matrix is a matrix with two rows and two columns. The target transformation matrix includes a first component, a second component, a third component, and a fourth component. The value of the first component and the value of the second component are different. The value of the third component and the value of the second component are the same, and the value of the fourth component is an opposite number of the value of the first component; or the value of the third component is an opposite number of the value of the second component, and the value of the fourth component and the value of the first component are the same.

The first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

It should be understood that the target transformation matrix involved in the decoder and the target transformation matrix involved in the encoder are a same matrix.

It should be noted that, the attribute transformation decoding method provided in this embodiment is a reverse process of attribute transformation encoding provided in the foregoing embodiment.

It should be understood that, according to the attribute transformation decoding method provided in this embodiment of this application, computational complexity of the decoder may be further reduced. For ease of understanding, refer to Table 3.

TABLE 3

| | Quantity of | Quantity of | Quantity of |
|---|---|---|---|
| | addition | subtraction | division |
| | operation times | operation times | operation times |
| Decoder 1 | 6193815 | 6193815 | 12387630 |
| Decoder 2 | 6193879 | 6193847 | 0 |

It should be understood that, the decoder 1 in Table 3 is a decoder that uses an attribute transformation decoding method in a related technology, and the decoder 2 is a decoder that uses the attribute transformation decoding method provided in this embodiment of this application. As shown in Table 3, compared with the attribute transformation decoding method in the conventional technology, a quantity of division operations is effectively reduced on the decoder that uses the attribute transformation decoding method provided in this embodiment of this application, thereby reducing the computational complexity of the decoder.

The attribute transformation encoding method provided in embodiments of this application may be performed by an attribute transformation encoding apparatus. In embodiments of this application, an example in which an attribute transformation encoding apparatus performs an attribute transformation encoding method is used to describe the attribute transformation encoding apparatus provided in embodiments of this application.

As shown in FIG. 6, an embodiment of this application further provides an attribute transformation encoding apparatus 600, including:
an obtaining module 601, configured to obtain geometry information of a to-be-encoded point cloud;
a generation module 602, configured to generate a transform tree structure corresponding to the to-be-encoded point cloud based on the geometry information of the to-be-encoded point cloud, where the transform tree structure includes N layers, and N is a positive integer greater than 1;
a first determining module 603, configured to perform, by using a preset target transformation matrix, a transformation operation on a first attribute coefficient corresponding to a child node of each first node in the N layers, to determine a second attribute coefficient corresponding to each first node, and predict a first attribute coefficient corresponding to each second node in the N layers, to determine an attribute coefficient residual corresponding to each second node, where the first node is a non-leaf node in the N layers, the second node is a node having no parent node in the N layers, and the target transformation matrix is a transformation matrix not including a floating point number;
a quantization module 604, configured to perform quantization processing on the second attribute coefficient corresponding to each first node, the attribute coefficient residual corresponding to each second node, and a first attribute coefficient corresponding to a child node of each first node in a top layer of the N layers; and
an encoding module 605, configured to encode the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

In some embodiments, the attribute transformation encoding apparatus 600 further includes:
a first operation module, configured to perform, based on N, a division operation on the first attribute coefficient corresponding to the child node of each first node in the top layer of the N layers; and
a second operation module, configured to perform, based on N and a quantity of layers that corresponds to a first layer, a division operation on a second attribute coefficient corresponding to each first node included in the first layer, and perform, based on N and the quantity of layers that corresponds to the first layer, a division operation on an attribute coefficient residual corresponding to each second node included in the first layer, where the first layer is any layer other than the top layer in the N layers.

In some embodiments, the attribute transformation encoding apparatus 600 further includes:
a third operation module, configured to: in a case that N is an even number, perform, based on N, a shift operation on the first attribute coefficient corresponding to the child node of each first node in the top layer of the N layers; and
a fourth operation module, configured to: in a case that N is an odd number, perform a division operation on the first attribute coefficient corresponding to the child node of each first node in the top layer of the N layers, and perform, based on N, a shift operation on a first attribute coefficient corresponding to each first node in the top layer of the N layers.

In some embodiments, the attribute transformation encoding apparatus 600 further includes:
a fifth operation module, configured to: in a case that a first value is an even number, perform, based on the first value, a shift operation on a second attribute coefficient corresponding to each first node included in a first layer, where the first value is determined based on N and a quantity of layers that corresponds to the first layer, and the first layer is any layer other than the top layer in the N layers;
a sixth operation module, configured to: in a case that a first value is an odd number, perform a division operation on a second attribute coefficient corresponding to each first node included in a first layer, and perform, based on the first value, a shift operation on the second attribute coefficient corresponding to each first node included in the first layer;
a seventh operation module, configured to: in a case that a second value is an even number, perform, based on the second value, a shift operation on an attribute coefficient residual corresponding to each second node included in a first layer, where the second value is determined based on N and a quantity of layers that corresponds to the first layer, and the second value is greater than the first value; and
an eighth operation module, configured to: in a case that a second value is an odd number, perform a division operation on an attribute coefficient residual corresponding to each second node included in a first layer, and perform, based on the second value, a shift operation on the attribute coefficient residual corresponding to each second node included in the first layer.

In some embodiments, the quantization module 604 is specifically configured to:
perform, by using a first quantization step, quantization processing on the first attribute coefficient corresponding to the child node of each first node in the top layer of the N layers, where the first quantization step is determined based on N;
perform, by using a second quantization step, quantization processing on a second attribute coefficient corresponding to a first node in a first layer, where the second quantization step is determined based on N and a quantity of layers that corresponds to the first layer, and the first layer is any layer other than the top layer in the N layers; and
perform, by using a third quantization step, quantization processing on an attribute coefficient residual corresponding to a second node in the first layer, where the third quantization step is determined based on N and the quantity of layers that corresponds to the first layer, and the third quantization step is greater than or equal to the second quantization step.

In some embodiments, the attribute transformation encoding apparatus 600 further includes:
a second determining module, configured to determine an original attribute value corresponding to each node in a bottom layer of the N layers as a first attribute coefficient corresponding to each node in the bottom layer of the N layers; and
a transformation module, configured to perform, based on the target transformation matrix, a transformation operation on a first attribute coefficient corresponding to a child node of each node in a second layer, to determine a first attribute coefficient corresponding to each node, where the second layer is any layer other than the bottom layer in the N layers.

In some embodiments, the target transformation matrix is a matrix with two rows and two columns. The target transformation matrix includes a first component, a second component, a third component, and a fourth component. The value of the first component and the value of the second component are different. The value of the third component and the value of the second component are the same, and the value of the fourth component is an opposite number of the value of the first component; or the value of the third component is an opposite number of the value of the second component, and the value of the fourth component and the value of the first component are the same.

The first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

In this embodiment of this application, the transformation operation is performed, by using the preset target transformation matrix, on the first attribute coefficient corresponding to the child node of each first node, to determine the second attribute coefficient corresponding to each first node, where the target transformation matrix is a transformation matrix not including a floating point number. Compared with a manner in a related technology in which transformation processing is performed, by using a transformation matrix including a floating point number, on an attribute coefficient corresponding to a node, in embodiments of this application, transformation processing is performed on an attribute coefficient by using a transformation matrix not including a floating point number, to avoid loss of computational precision, thereby improving accuracy of an encoding result.

The apparatus embodiment corresponds to the encoding method embodiment shown in FIG. 3, and implementation processes and implementations of the encoder in the method embodiment described above can be applied to the apparatus embodiment, and same technical effects can be achieved.

The attribute transformation decoding method provided in embodiments of this application may be performed by an attribute transformation decoding apparatus. In embodiments of this application, an example in which an attribute transformation decoding apparatus performs an attribute transformation decoding method is used to describe the attribute transformation decoding apparatus provided in embodiments of this application.

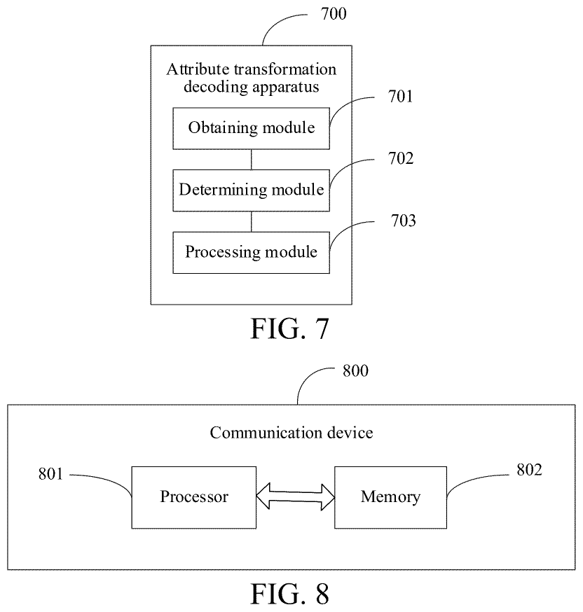

As shown in FIG. 7, an embodiment of this application further provides an attribute transformation decoding apparatus 700, including:
an obtaining module 701, configured to obtain a target bitstream;
a determining module 702, configured to determine, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node, where the first node is a non-leaf node in the N layers, the second node is a node having no parent node in the N layers, and N is a positive integer greater than 1; and
a processing module 703, configured to perform, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determine, based on the attribute coefficient residual corresponding to each second node, a reconstructed attribute value corresponding to each second node in the N layers, where the target transformation matrix is a transformation matrix not including a floating point number.

In some embodiments, the determining module 702 is specifically configured to:

decode the obtained target bitstream, to obtain geometry information of a to-be-decoded point cloud, a first target attribute coefficient corresponding to each first node in the top layer of the N layers, a second target attribute coefficient corresponding to each first node, and a target attribute coefficient residual corresponding to each second node; and

construct a transform tree structure based on the geometry information of the to-be-decoded point cloud, and perform dequantization processing on the first target attribute coefficient corresponding to each first node in the top layer of the N layers, the second target attribute coefficient corresponding to each first node, and the target attribute coefficient residual corresponding to each second node, to obtain the first attribute coefficient corresponding to the child node of each first node in the top layer of the N layers, the second attribute coefficient corresponding to each first node, and the attribute coefficient residual corresponding to each second node.

In some embodiments, the determining module 702 is further specifically configured to:
perform, by using a first quantization step, dequantization processing on the first target attribute coefficient corresponding to each first node in the top layer of the N layers, where the first quantization step is determined based on N;
perform, by using a second quantization step, quantization processing on a second target attribute coefficient corresponding to a first node in a first layer, where the second quantization step is determined based on N and a quantity of layers that corresponds to the first layer, and the first layer is any layer other than the top layer in the N layers; and
perform, by using a third quantization step, quantization processing on a target attribute coefficient residual corresponding to a second node in the first layer, where the third quantization step is determined based on N and the quantity of layers that corresponds corresponding to the first layer, and the third quantization step is greater than or equal to the second quantization step.

In some embodiments, the attribute transformation decoding apparatus 700 further includes:
a first operation module, configured to perform, based on N, a multiplication operation on the first attribute coefficient corresponding to the child node of each first node in the top layer of the N layers; and
a second operation module, configured to perform, based on N and a quantity of layers that corresponds to a first layer, a multiplication operation on a second attribute coefficient corresponding to each first node included in the first layer, and perform, based on N and the quantity of layers that corresponds to the first layer, a multiplication operation on an attribute coefficient residual corresponding to each second node included in the first layer, where the first layer is any layer other than the top layer in the N layers.

In some embodiments, the attribute transformation decoding apparatus 700 further includes:
a third operation module, configured to: in a case that N is an even number, perform, based on N, a shift operation on the first attribute coefficient corresponding to the child node of each first node in the top layer of the N layers; and
a fourth operation module, configured to: in a case that N is an odd number, perform a multiplication operation on the first attribute coefficient corresponding to the child node of each first node in the top layer of the N layers, and perform, based on N, a shift operation on a first attribute coefficient corresponding to each first node in the top layer of the N layers.

In some embodiments, the attribute transformation decoding apparatus 700 further includes:
a fifth operation module, configured to: in a case that a first value is an even number, perform, based on the first value, a shift operation on a second attribute coefficient corresponding to each first node included in a first layer, where the first value is determined based on N and a quantity of layers that corresponds to the first layer, and the first layer is any layer other than the top layer in the N layers;
a sixth operation module, configured to: in a case that a first value is an odd number, perform a multiplication operation on a second attribute coefficient corresponding to each first node included in a first layer, and perform, based on the first value, a shift operation on the second attribute coefficient corresponding to each first node included in the first layer;
a seventh operation module, configured to: in a case that a second value is an even number, perform, based on the second value, a shift operation on an attribute coefficient residual corresponding to each second node included in a first layer, where the second value is determined based on N and a quantity of layers that corresponds to the first layer, and the second value is greater than the first value; and
an eighth operation module, configured to: in a case that a second value is an odd number, perform a multiplication operation on an attribute coefficient residual corresponding to each second node included in a first layer, and perform, based on the second value, a shift operation on the attribute coefficient residual corresponding to each second node included in the first layer.

In some embodiments, the target transformation matrix is a matrix with two rows and two columns. The target transformation matrix includes a first component, a second component, a third component, and a fourth component. The value of the first component and the value of the second component are different. The value of the third component and the value of the second component are the same, and the value of the fourth component is an opposite number of the value of the first component; or the value of the third component is an opposite number of the value of the second component, and the value of the fourth component and the value of the first component are the same.

The first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

The attribute transformation decoding apparatus provided in embodiments of this application can implement processes implemented in the method embodiment of FIG. 5, and same technical effects are achieved. To avoid repetition, details are not described herein again.

The attribute transformation encoding apparatus and the attribute transformation decoding apparatus in embodiments of this application may each be an electronic device, for example, an electronic device having an operating system, or may each be a component, for example, an integrated circuit or a chip in an electronic device. The electronic device may be a terminal, or may be another device other than a terminal. For example, the terminal may include but is not limited to the foregoing types of terminals, and the another device may be a server, a network attached storage (Network Attached Storage, NAS), or the like. This is not specifically limited in embodiments of this application.

In some embodiments, as shown in FIG. 8, an embodiment of this application further provides a communication device 800, including a processor 801 and a memory 802. The memory 802 stores a program or instructions that may be run on the processor 801. For example, if the communication device 800 is a terminal, when the program or instructions are executed by the processor 801, the steps of the foregoing attribute transformation encoding method embodiment or the steps of the foregoing attribute transformation decoding method embodiment are implemented, and same technical effects can be achieved.

An embodiment of this application further provides a terminal, including a processor and a communication interface. The processor is configured to perform the following operations:
obtaining geometry information of a to-be-encoded point cloud;
generating a transform tree structure corresponding to the to-be-encoded point cloud based on the geometry information of the to-be-encoded point cloud;
performing, by using a preset target transformation matrix, a transformation operation on a first attribute coefficient corresponding to a child node of each first node in the N layers, to determine a second attribute coefficient corresponding to each first node, and predicting a first attribute coefficient corresponding to each second node in the N layers, to determine an attribute coefficient residual corresponding to each second node;
performing quantization processing on the second attribute coefficient corresponding to each first node, the attribute coefficient residual corresponding to each second node, and a first attribute coefficient corresponding to a child node of each first node in a top layer of the N layers; and
encoding the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

Alternatively, the processor is configured to perform the following operations:
obtaining a target bitstream;
determining, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node; and
performing, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determining, based on the attribute coefficient residual corresponding to each second node, a reconstructed attribute value corresponding to each second node in the N layers.

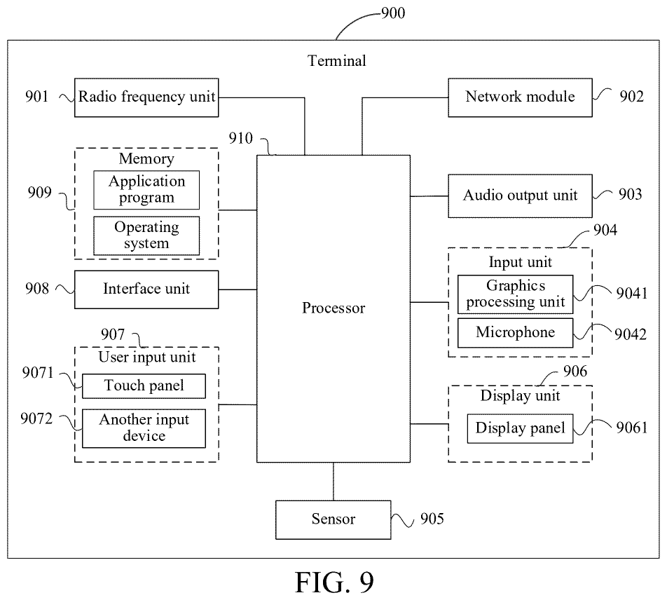

This terminal embodiment corresponds to the foregoing method embodiment on a terminal side. Implementation processes and implementations of the foregoing method embodiment can be applied to this terminal embodiment, and same technical effects can be achieved. Specifically, FIG. 9 is a diagram of a hardware structure of a terminal according to an embodiment of this application.

The terminal 900 includes but is not limited to: components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (such as a battery) that supplies power to the components. The power supply may be logically connected to the processor 910 through a power management system, to implement functions such as charging, discharging, and power consumption management by using the power management system. The structure of the terminal shown in FIG. 9 does not constitute a limitation on the terminal, and the terminal may include more or fewer components than those shown in the figure, or some components are combined, or a different component deployment may be used. Details are not described herein.

It should be understood that, in this embodiment of this application, the input unit 904 may include a graphics processing unit (Graphics Processing Unit, GPU) 9041 and a microphone 9042, and the graphics processing unit 9041 processes image data of still images or videos obtained by an image capture apparatus (for example, a camera) in a video capture mode or an image capture mode. The display unit 906 may include a display panel 9061, which may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include, but is not limited to, a physical keyboard, a functional key (such as a volume control key or a switch key), a track ball, a mouse, and a joystick, which is not described herein in detail.

In this embodiment of this application, after receiving downlink data from a network side device, the radio frequency unit 901 may transmit the downlink data to the processor 99 for processing. The radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or instruction and various data. The memory 909 may mainly include a first storage area in which programs or instructions are stored and a second storage area in which data is stored. In the first storage area, the following may be stored: an operating system, application programs or instructions required by at least one function (for example, a sound playing function or an image display function), and the like. In addition, the memory 909 may include a volatile memory or a non-volatile memory, or may include both a volatile memory and a non-volatile memory. The non-volatile memory may be a read-only memory (Read-Only Memory, ROM), a programmable ROM (Programmable ROM, PROM), an erasable PROM (Erasable PROM, EPROM), an electrically EPROM (Electrically EPROM, EEPROM), or a flash memory. Volatile memories may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus dynamic random access memory (Direct Rambus RAM, DRRAM). The memory 909 in this embodiment of this application includes but is not limited to these memories and any other memory of a suitable type.

The processor 910 may include one or more processing units. In some embodiments, the processor 910 integrates an application processor and a modem processor. The application processor mainly processes operations related to an operating system, a user interface, an application program, and the like. The modem processor mainly processes wireless communication signals, for example, a baseband processor. It may be understood that the foregoing modem may not be integrated into the processor 910.

The processor 910 is configured to perform the following operations:
obtaining geometry information of a to-be-encoded point cloud;
generating a transform tree structure corresponding to the to-be-encoded point cloud based on the geometry information of the to-be-encoded point cloud;
performing, by using a preset target transformation matrix, a transformation operation on a first attribute coefficient corresponding to a child node of each first node in the N layers, to determine a second attribute coefficient corresponding to each first node, and predicting a first attribute coefficient corresponding to each second node in the N layers, to determine an attribute coefficient residual corresponding to each second node;
performing quantization processing on the second attribute coefficient corresponding to each first node, the attribute coefficient residual corresponding to each second node, and a first attribute coefficient corresponding to a child node of each first node in a top layer of the N layers; and
encoding the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

Alternatively, the processor 910 is further configured to perform the following operations:
obtaining a target bitstream;
determining, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node; and
performing, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determining, based on the attribute coefficient residual corresponding to each second node, a reconstructed attribute value corresponding to each second node in the N layers.

An embodiment of this application further provides a readable storage medium, storing a program or instructions. When the program or the instructions are executed by a processor, the processes of the foregoing attribute transformation encoding method embodiment or the processes of the foregoing attribute transformation decoding method embodiment are implemented, and same technical effects can be achieved. To avoid repetition, details are not described herein again.

The processor may be a processor of the terminal in foregoing embodiment. The readable storage medium includes a computer-readable storage medium, for example, a computer read-only memory ROM, a random access memory RAM, a magnetic disk, an optical disc, or the like. An embodiment of this application further provides a chip, including a processor and a communication interface. The communication interface is coupled to the processor. The processor is configured to run a program or instructions, to implement the processes of the foregoing attribute transformation encoding method embodiment or the processes of the foregoing attribute transformation decoding method embodiment, and same technical effects can be achieved. To avoid repetition, details are not described herein again.

It should be understood that the chip mentioned in this embodiment of this application may also be referred to as a system on chip, a system chip, a system on a chip, a system-on-a-chip, or the like. An embodiment of this application further provides a computer program/program product. The computer program/program product is stored in a storage medium. The computer program/program product is executed by at least one processor, to implement the processes of the foregoing attribute transformation encoding method embodiment or the processes of the foregoing attribute transformation decoding method embodiment, and same technical effects can be achieved. To avoid repetition, details are not described herein again.

It should be noted that, the terms “include”, “comprise”, or any other variations thereof in this specification are intended to cover a non-exclusive inclusion, such that a process, method, article, or apparatus including a series of elements not only includes those elements, but also includes other elements that are not explicitly listed, or also includes elements inherent to such process, method, article, or apparatus. Without more restrictions, the elements defined by the sentence “including a . . . ” or “comprising a” do not exclude existence of other identical elements in the process, the method, the article, or the apparatus including the elements. In addition, it should be noted that the scope of the method and apparatus of embodiments of this application is not limited to performing functions in the order shown or discussed, but may include performing functions in a substantially concurrent manner or in reverse order depending on the functionality involved, for example, the method described may be performed in an order different from that described, and various steps may further be added, omitted, or combined. In addition, features described with reference to some examples may be combined in other examples. According to the descriptions in the foregoing implementations, a person skilled in the art may clearly learn that the method according to the foregoing embodiment may be implemented by relying on software and a commodity hardware platform or by using hardware. Based on such an understanding, the technical solutions of this application essentially or the part contributing to the conventional technology may be implemented in a form of a computer software product. The computer software product is stored in a storage medium (such as an ROM/RAM, a magnetic disk, or an optical disc) and includes several instructions for enabling a terminal (which may be a mobile phone, a computer, a server, an air conditioner, a network device, or the like) to perform the methods described in embodiments of this application.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make many modifications without departing from the principles of this application and the protection scope of the claims, and all the modifications shall fall within the protection scope of this application.

What is claimed is:

1. An attribute transformation encoding method, comprising:
obtaining, by an encoder, geometry information of a to-be-encoded point cloud;
generating, by the encoder, a transform tree structure corresponding to the to-be-encoded point cloud based on the geometry information of the to-be-encoded point cloud, wherein the transform tree structure comprises N layers, and N is a positive integer greater than 1;
performing, by the encoder by using a preset target transformation matrix, a transformation operation on a first attribute coefficient corresponding to a child node of each first node in the N layers, to determine a second attribute coefficient corresponding to each first node, and predicting a first attribute coefficient corresponding to each second node in the N layers, to determine an attribute coefficient residual corresponding to each second node, wherein the first node is a non-leaf node in the N layers, the second node is a node having no parent node in the N layers, and the target transformation matrix is a transformation matrix not comprising a floating point number;
performing, by the encoder, quantization processing on the second attribute coefficient corresponding to each first node, the attribute coefficient residual corresponding to each second node, and a first attribute coefficient corresponding to a child node of each first node in a top layer of the N layers; and
encoding, by the encoder, the second attribute coefficient corresponding to each first node, the attribute coefficient residual corresponding to each second node, and the first attribute coefficient corresponding to the child node of each first node in the top layer of the N layers that are obtained after quantization processing and the geometry information of the to-be-encoded point cloud, to generate a target bitstream.

2. The method according to claim 1, wherein before performing, by the encoder, quantization processing on the second attribute coefficient corresponding to each first node, the attribute coefficient residual corresponding to each second node, and the first attribute coefficient corresponding to the child node of each first node in the top layer of the N layers, the method further comprises:
performing, by the encoder based on N, a division operation on the first attribute coefficient corresponding to the child node of each first node in the top layer of the N layers; and
performing, by the encoder based on N and a quantity of layers that corresponds to a first layer, a division operation on a second attribute coefficient corresponding to each first node comprised in the first layer, and performing, based on N and the quantity of layers that corresponds to the first layer, a division operation on an attribute coefficient residual corresponding to each second node comprised in the first layer, wherein the first layer is any layer other than the top layer in the N layers.

3. The method according to claim 1, wherein before performing, by the encoder, quantization processing on the second attribute coefficient corresponding to each first node, the attribute coefficient residual corresponding to each second node, and the first attribute coefficient corresponding to the child node of each first node in the top layer of the N layers, the method further comprises:
in a case that N is an even number, performing, by the encoder based on N, a shift operation on the first attribute coefficient corresponding to the child node of each first node in the top layer of the N layers; or
in a case that Nis an odd number, performing, by the encoder, a division operation on the first attribute coefficient corresponding to the child node of each first node in the top layer of the N layers, and performing, based on N, a shift operation on a first attribute coefficient corresponding to each first node in the top layer of the N layers.

4. The method according to claim 3, wherein the method further comprises:
in a case that a first value is an even number, performing, by the encoder based on the first value, a shift operation on a second attribute coefficient corresponding to each first node comprised in a first layer, wherein the first value is determined based on N and a quantity of layers that corresponds to the first layer, and the first layer is any layer other than the top layer in the N layers; or
in a case that a first value is an odd number, performing, by the encoder, a division operation on a second attribute coefficient corresponding to each first node comprised in a first layer, and performing, based on the first value, a shift operation on the second attribute coefficient corresponding to each first node comprised in the first layer; or
in a case that a second value is an even number, performing, by the encoder based on the second value, a shift operation on an attribute coefficient residual corresponding to each second node comprised in a first layer, wherein the second value is determined based on N and a quantity of layers that corresponds to the first layer, and the second value is greater than the first value; or
in a case that a second value is an odd number, performing, by the encoder, a division operation on an attribute coefficient residual corresponding to each second node comprised in a first layer, and performing, based on the second value, a shift operation on the attribute coefficient residual corresponding to each second node comprised in the first layer.

5. The method according to claim 1, wherein performing, by the encoder, quantization processing on the second attribute coefficient corresponding to each first node, the attribute coefficient residual corresponding to each second node, and the first attribute coefficient corresponding to the child node of each first node in the top layer of the N layers comprises:
performing, by the encoder by using a first quantization step, quantization processing on the first attribute coefficient corresponding to the child node of each first node in the top layer of the N layers, wherein the first quantization step is determined based on N;
performing, by the encoder by using a second quantization step, quantization processing on a second attribute coefficient corresponding to a first node in a first layer, wherein the second quantization step is determined based on N and a quantity of layers that corresponds to the first layer, and the first layer is any layer other than the top layer in the N layers; and
performing, by the encoder by using a third quantization step, quantization processing on an attribute coefficient residual corresponding to a second node in the first layer, wherein the third quantization step is determined based on N and the quantity of layers that corresponds to the first layer, and the third quantization step is greater than or equal to the second quantization step.

6. The method according to claim 1, wherein before performing, by the encoder by using the preset target transformation matrix, the transformation operation on the first attribute coefficient corresponding to the child node of each first node in the N layers, to determine the second attribute coefficient corresponding to each first node, and predicting the first attribute coefficient corresponding to each second node in the N layers, to determine the attribute coefficient residual corresponding to each second node, the method further comprises:
determining, by the encoder, an original attribute value corresponding to each node in a bottom layer of the N layers as a first attribute coefficient corresponding to each node in the bottom layer of the N layers; and
performing, by the encoder based on the target transformation matrix, a transformation operation on a first attribute coefficient corresponding to a child node of each node in a second layer, to determine a first attribute coefficient corresponding to each node, wherein the second layer is any layer other than the bottom layer in the N layers.

7. The method according to claim 1, wherein the target transformation matrix is a matrix with two rows and two columns, the target transformation matrix comprises a first component, a second component, a third component, and a fourth component, the value of the first component and the value of the second component are different, the value of the third component and the value of the second component are the same, and the value of the fourth component is an opposite number of the value of the first component, or the value of the third component is an opposite number of the value of the second component, and the value of the fourth component and the value of the first component are the same, wherein
the first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

8. An attribute transformation decoding method, comprising:
obtaining, by a decoder, a target bitstream;
determining, by the decoder based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node, wherein the first node is a non-leaf node in the N layers, the second node is a node having no parent node in the N layers, and N is a positive integer greater than 1; and
performing, by the decoder by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determining, based on the attribute coefficient residual corresponding to each second node, a reconstructed attribute value corresponding to each second node in the N layers, wherein the target transformation matrix is a transformation matrix not comprising a floating point number.

9. The method according to claim 8, wherein determining, by the decoder based on the decoding result of the target bitstream, the first attribute coefficient corresponding to the child node of each first node in the top layer of the N layers corresponding to the target bitstream, the second attribute coefficient corresponding to each first node, and the attribute coefficient residual corresponding to each second node comprises:
decoding, by the decoder, the obtained target bitstream, to obtain geometry information of a to-be-decoded point cloud, a first target attribute coefficient corresponding to each first node in the top layer of the N layers, a second target attribute coefficient corresponding to each first node, and a target attribute coefficient residual corresponding to each second node; and
constructing, by the decoder, a transform tree structure based on the geometry information of the to-be-decoded point cloud, and performing dequantization processing on the first target attribute coefficient corresponding to each first node in the top layer of the N layers, the second target attribute coefficient corresponding to each first node, and the target attribute coefficient residual corresponding to each second node, to obtain the first attribute coefficient corresponding to the child node of each first node in the top layer of the N layers, the second attribute coefficient corresponding to each first node, and the attribute coefficient residual corresponding to each second node.

10. The method according to claim 9, wherein performing, by the decoder, dequantization processing on the first target attribute coefficient corresponding to each first node in the top layer of the N layers, the second target attribute coefficient corresponding to each first node, and the target attribute coefficient residual corresponding to each second node comprises:
performing, by the decoder by using a first quantization step, dequantization processing on the first target attribute coefficient corresponding to each first node in the top layer of the N layers, wherein the first quantization step is determined based on N;
performing, by the decoder by using a second quantization step, quantization processing on a second target attribute coefficient corresponding to a first node in a first layer, wherein the second quantization step is determined based on N and a quantity of layers that corresponds to the first layer, and the first layer is any layer other than the top layer in the N layers; and
performing, by the decoder by using a third quantization step, quantization processing on a target attribute coefficient residual corresponding to a second node in the first layer, wherein the third quantization step is determined based on N and the quantity of layers that corresponds to the first layer, and the third quantization step is greater than or equal to the second quantization step.

11. The method according to claim 8, wherein before performing, by the decoder by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the method further comprises:
performing, by the decoder based on N, a multiplication operation on the first attribute coefficient corresponding to the child node of each first node in the top layer of the N layers; and
performing, by the decoder based on N and a quantity of layers that corresponds to a first layer, a multiplication operation on a second attribute coefficient corresponding to each first node comprised in the first layer, and performing, based on N and the quantity of layers that corresponds to the first layer, a multiplication operation on an attribute coefficient residual corresponding to each second node comprised in the first layer, wherein the first layer is any layer other than the top layer in the N layers.

12. The method according to claim 8, wherein before performing, by the decoder by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the method further comprises:
in a case that N is an even number, performing, by the decoder based on N, a shift operation on the first attribute coefficient corresponding to the child node of each first node in the top layer of the N layers; or
in a case that N is an odd number, performing, by the decoder, a multiplication operation on the first attribute coefficient corresponding to the child node of each first node in the top layer of the N layers, and performing, based on N, a shift operation on a first attribute coefficient corresponding to each first node in the top layer of the N layers.

13. The method according to claim 12, wherein the method further comprises:
in a case that a first value is an even number, performing, by the decoder based on the first value, a shift operation on a second attribute coefficient corresponding to each first node comprised in a first layer, wherein the first value is determined based on N and a quantity of layers that corresponds to the first layer, and the first layer is any layer other than the top layer in the N layers; or
in a case that a first value is an odd number, performing, by the decoder, a multiplication operation on a second attribute coefficient corresponding to each first node comprised in a first layer, and performing, based on the first value, a shift operation on the second attribute coefficient corresponding to each first node comprised in the first layer; or
in a case that a second value is an even number, performing, by the decoder based on the second value, a shift operation on an attribute coefficient residual corresponding to each second node comprised in a first layer, wherein the second value is determined based on N and a quantity of layers that corresponds to the first layer, and the second value is greater than the first value; or
in a case that a second value is an odd number, performing, by the decoder, a multiplication operation on an attribute coefficient residual corresponding to each second node comprised in a first layer, and performing, based on the second value, a shift operation on the attribute coefficient residual corresponding to each second node comprised in the first layer.

14. The method according to claim 8, wherein the target transformation matrix is a matrix with two rows and two columns, the target transformation matrix comprises a first component, a second component, a third component, and a fourth component, the value of the first component and the value of the second component are different, the value of the third component and the value of the second component are the same, and the value of the fourth component is an opposite number of the value of the first component, or the value of the third component is an opposite number of the value of the second component, and the value of the fourth component and the value of the first component are the same, wherein
the first component is located in a first row and a first column of the target transformation matrix, the second component is located in the first row and a second column of the target transformation matrix, the third component is located in a second row and the first column of the target transformation matrix, and the fourth component is located in the second row and the second column of the target transformation matrix.

15. A chip, comprising:
one or more processors; and
a communication interface, coupled to the one or more processors,
wherein the one or more processors is configured to run a program or instructions, to perform operations comprising:
obtaining a target bitstream;
determining, based on a decoding result of the target bitstream, a first attribute coefficient corresponding to a child node of each first node in a top layer of N layers corresponding to the target bitstream, a second attribute coefficient corresponding to each first node, and an attribute coefficient residual corresponding to each second node, wherein the first node is a non-leaf node in the N layers, the second node is a node having no parent node in the N layers, and Nis a positive integer greater than 1; and
performing, by using a preset target transformation matrix, inverse transformation on the first attribute coefficient corresponding to the child node of each first node in the top layer of the N layers and the second attribute coefficient corresponding to each first node, to obtain a reconstructed attribute value corresponding to each first node in the N layers, and determining, based on the attribute coefficient residual corresponding to each second node, a reconstructed attribute value corresponding to each second node in the N layers, wherein the target transformation matrix is a transformation matrix not comprising a floating point number.

16. The chip according to claim 15, wherein determining, based on the decoding result of the target bitstream, the first attribute coefficient corresponding to the child node of each first node in the top layer of the N layers corresponding to the target bitstream, the second attribute coefficient corresponding to each first node, and the attribute coefficient residual corresponding to each second node comprises:
decoding the obtained target bitstream, to obtain geometry information of a to-be-decoded point cloud, a first target attribute coefficient corresponding to each first node in the top layer of the N layers, a second target attribute coefficient corresponding to each first node, and a target attribute coefficient residual corresponding to each second node; and
constructing a transform tree structure based on the geometry information of the to-be-decoded point cloud, and performing dequantization processing on the first target attribute coefficient corresponding to each first node in the top layer of the N layers, the second target attribute coefficient corresponding to each first node, and the target attribute coefficient residual corresponding to each second node, to obtain the first attribute coefficient corresponding to the child node of each first node in the top layer of the N layers, the second attribute coefficient corresponding to each first node, and the attribute coefficient residual corresponding to each second node.

17. The chip according to claim 16, wherein performing dequantization processing on the first target attribute coefficient corresponding to each first node in the top layer of the N layers, the second target attribute coefficient corresponding to each first node, and the target attribute coefficient residual corresponding to each second node comprises:
performing, by using a first quantization step, dequantization processing on the first target attribute coefficient corresponding to each first node in the top layer of the N layers, wherein the first quantization step is determined based on N;
performing, by using a second quantization step, quantization processing on a second target attribute coefficient corresponding to a first node in a first layer, wherein the second quantization step is determined based on N and a quantity of layers that corresponds to the first layer, and the first layer is any layer other than the top layer in the N layers; and
performing, by using a third quantization step, quantization processing on a target attribute coefficient residual corresponding to a second node in the first layer, wherein the third quantization step is determined based on N and the quantity of layers that corresponds to the first layer, and the third quantization step is greater than or equal to the second quantization step.

18. The chip according to claim 15, wherein before performing, by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the operations further comprise:
performing, based on N, a multiplication operation on the first attribute coefficient corresponding to the child node of each first node in the top layer of the N layers; and
performing, based on N and a quantity of layers that corresponds to a first layer, a multiplication operation on a second attribute coefficient corresponding to each first node comprised in the first layer, and performing, based on N and the quantity of layers that corresponds to the first layer, a multiplication operation on an attribute coefficient residual corresponding to each second node comprised in the first layer, wherein the first layer is any layer other than the top layer in the N layers.

19. The chip according to claim 15, wherein before performing, by using the preset target transformation matrix, inverse transformation on the first attribute coefficient corresponding to the child node of each first node in the top layer of the N layers and the second attribute coefficient corresponding to each first node, and predicting the attribute coefficient residual corresponding to each second node, to obtain the reconstructed attribute value corresponding to each node in the N layers, the operations further comprise:
in a case that Nis an even number, performing, based on N, a shift operation on the first attribute coefficient corresponding to the child node of each first node in the top layer of the N layers; and
in a case that N is an odd number, performing a multiplication operation on the first attribute coefficient corresponding to the child node of each first node in the top layer of the N layers, and performing, based on N, a shift operation on a first attribute coefficient corresponding to each first node in the top layer of the N layers.

20. A chip, comprising:
a processor; and
a communication interface, coupled to the processor,
wherein the processor is configured to run a program or instructions, to perform the attribute transformation encoding method according to claim 1.
